(19) United States
(12) Patent Application Publication
(10) Pub. No.: US 2025/0170437 A1
(43) Pub. Date: May 29, 2025

(54) AIR TO GROUND GUIDED WILDFIRE EXTINGUISHING DEVICE AND CONTROL METHOD THEREOF

(71) Applicant: Gyeong Phil PARK, Seoul (KR)

(72) Inventor: Gyeong Phil PARK, Seoul (KR)

(21) Appl. No.: 18/816,805

(22) Filed: Aug. 27, 2024

(30) Foreign Application Priority Data
Nov. 24, 2023 (KR) 10-2023-0166152
Jun. 20, 2024 (KR) 10-2024-0080395

(51) Int. Cl. A62C 3/02; A62C 37/00; B64U 10/13; B64U 101/47; G06V 20/17

(52) U.S. Cl. CPC A62C 3/0242; A62C 37/00; B64U 10/13; B64U 2101/47; G06V 20/17

(57) ABSTRACT

An air-to-ground guided wildfire extinguishing device and method is provided. The device includes a camera module that captures an image including a fire scene, a distance measurement sensor that measures a distance from a ground, a control unit that receives the image from the camera module, recognizes at least one of a wildfire shape, smoke shape, and object included in the image, detects, identifies, or tracks a pre-learned target, controls a moving direction of the wildfire extinguishing device to correspond to the target, and determines a terminal altitude based on altitude detection data obtained from the distance measurement sensor, and a fire extinguishing material tank that is configured to spray a fire extinguishing material on the fire scene based on a signal received from the control unit.

### CROSS-REFERENCE TO RELATED APPLICATIONS

This application claims the priority of Korean Patent Applications Nos. 10-2023-0166152 filed on Nov. 24, 2023, and 10-2024-0080395 filed on Jun. 20, 2024, in the Korean Intellectual Property Office, the entire disclosures of which are incorporated herein by reference.

### BACKGROUND

### Field

The present disclosure relates to an air-to-ground guided wildfire extinguishing device and a method for controlling the same, and more particularly, an air-to-ground guided wildfire extinguishing device that is capable of extinguishing a wildfire in the shortest time and a method for controlling the same.

### Description of the Related Art

Due to global warming and climate change, the frequency of occurrence of wildfires is expected to increase by 30% or more by 2050, but existing firefighting equipment such as firefighting helicopters have many difficulties in extinguishing wildfires.

Causes that make wildfires more frequent and stronger include high temperatures, dry thunderstorms, strong winds, etc., due to climate change.

In Korea, about 550 or more wildfires occur on average each year, and 6,500 ha (22 times the area of Yeouido) of forest is lost every year. According to the United Nations Environment Program wildfire report 2022, extreme wildfires are expected to increase by 30% by 2050 due to climate change and global warming.

In fact, in Korea, wildfires in Gangwon-do and Gyeongsangbuk-do in 2022 resulted in damages of 226.1 billion won and recovery costs of 417 billion won.

Overseas, in 2022, wildfires continued for a year in Canada, resulting in a damaged area of 137,000 km₂ (about 1.3 times the area of South Korea) and 290 million tons of carbon emissions. In 2023, a wildfire on Maui Island, Hawaii, caused damage, killing 101 people and leaving 1,300 people missing.

In the event of a national disaster like this, many researches are underway on how to extinguish wildfires faster and more accurately than the spread of wildfires using existing firefighting helicopters.

However, since existing firefighting helicopters have limited fire extinguishing capacity due to maximum take-off weight limits, and fire extinguishing liquid must be recharged from a nearby lake when dropped once, it takes a rather long time to extinguish a wildfire, and it is not easy to drop fire extinguishing water to an accurate point where a fire started because the fire extinguishing water is dropped from an altitude of 15 m or more.

In addition, a wildfire spreads due to a large amount of air introduced due to the ground effect of firefighting helicopters, and the wildfire spreads at an average speed of 22.97 km/h, which makes it difficult for the firefighting helicopters to keep up with the rate of spread of the wildfire.

Furthermore, in the related art, when extinguishing wildfires using firefighting helicopters or firefighting drones, there were problems of the maximum take-off weight limit (e.g. 8,000 L), and an extended time (e.g., 30 minutes or more) taken to recharge fire extinguishing water from reservoirs, etc.

### SUMMARY

An object of the present disclosure is to provide an air-to-ground guided wildfire extinguishing device that is capable of extinguishing a wildfire within a shortest time by dropping a plurality of extinguishing devices in the air, using a manned or unmanned aircraft with a high maximum take-off weight, onto the wildfire with an error within a very small radius through precise guidance by utilizing a deep learning object detection technology and robot control technology.

Another object of the present disclosure is to provide an air-to-ground guided wildfire extinguishing method.

The tasks to be solved in the present disclosure may not be limited to the aforementioned, and other problems to be solved by the present disclosure will be obviously understood by a person skilled in the art based on the following description.

In order to achieve one object of the present disclosure, according to an aspect of the present disclosure, may include a camera module that captures an image including a fire scene, a distance measurement sensor that measures a distance from a ground, a control unit that receives the image from the camera module, recognizes at least one of a wildfire shape, smoke shape, and object included in the image, detects, identifies, or tracks a pre-learned target, controls a moving direction of the wildfire extinguishing device to correspond to the target, and determines a terminal altitude based on altitude detection data obtained from the distance measurement sensor, and a fire extinguishing material tank that is configured to spray a fire extinguishing material on the fire scene based on a signal received from the control unit.

A method for controlling an air-to-ground guided wildfire extinguishing device according to the present disclosure to solve another problem may include (a) acquiring an image of a fire scene using a camera module, the image including at least one of a wildfire shape, smoke shape, and object, (b) analyzing and tracking a target through a pre-learned model based on the acquired image using a control unit, (c) guiding the wildfire extinguishing device in a certain direction among a plurality of directions using the control unit, (d) measuring an altitude of the wildfire extinguishing device using a distance measurement sensor, and (e) spraying a fire extinguishing material using a fire extinguishing material tank when it is determined that the measured altitude has reached a terminal altitude.

Meanwhile, information related to an air-to-ground guided wildfire extinguishing method according to the present disclosure to achieve the another object may be stored in a computer-readable recording medium.

Other details of the present disclosure are included in the detailed description and drawings.

According to the present disclosure, a wildfire extinguishing device uses a camera module and is designed to be reusable, lowering the production cost of a product, and reducing an economic burden even when a large quantity of fire extinguishing water is dropped.

According to the present disclosure, a Nonafilter is an algorithm that continuously tracks and controls the most valuable targets among them when looking at the ground from a camera in the air.

By using a filter that performs intuitive position control of a wildfire extinguishing device after deep learning, a calculation amount is reduced and the intuitive posture control is allowed, compared to a Kalman filter that controls the position of a robot in the related art.

In addition, a wildfire extinguishing device can be dropped on a point where a fire started through a large manned and unmanned transport aircraft with a high maximum take-off weight.

A wildfire extinguishing device is designed with a reuse structure. In order to reduce potential energy when falling in the air, a wildfire extinguishing device can be fully reused through a high-drag design that reduces potential energy or the falling speed through the injection of high-pressure fire extinguishing fluid. When reusing wildfire extinguishing device, the cost can be innovatively reduced if fire extinguishing powder is recharged and reused.

The effects of the present disclosure are not limited to those effects mentioned above, and other effects not mentioned may be clearly understood by those skilled in the art from the description of the appended claims.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a plan photo of an air-to-ground guided wildfire extinguishing device according to one embodiment of the present disclosure;

FIG. 2 is a block diagram of the wildfire extinguishing device illustrated in FIG. 1;

FIG. 3 is a flowchart illustrating a method for controlling an air-to-ground guided wildfire extinguishing device according to another embodiment of the present disclosure;

FIG. 4 is a deep learning image of a nighttime wildfire that actually occurred in Colorado, USA in August 2020;

FIG. 5 is an image obtained by dividing an image of a fire scene taken from the front using a deep learning filter according to a first embodiment of the present disclosure;

FIG. 6 is a diagram illustrating a direction in which a wildfire extinguishing device moves in the image of the fire scene divided according to the first embodiment of the present disclosure illustrated in FIG. 5;

FIG. 7 is an image obtained by dividing an image of a fire scene taken from the front using a deep learning filter according to a second embodiment of the present disclosure;

FIG. 8 is a diagram illustrating a direction in which a wildfire extinguishing device moves in the image of the fire scene divided according to the second embodiment of the present disclosure illustrated in FIG. 7;

FIG. 9 is a plan image of the wildfire extinguishing device in which fin angles of fins attached to a servomotor in the wildfire extinguishing device illustrated in FIG. 1 has been adjusted by certain angles in X-axis and Y-axis directions;

FIG. 10 is a photo (a) of extinguishing a wildfire using an existing firefighting helicopter and a photo (b) of a wildfire extinguishing device being dropped from an artificial intelligence (AI) air-to-ground guidance control device for extinguishing a wildfire according to the present disclosure;

FIG. 11 is an expected photo of a wildfire extinguishing device spraying fire extinguishing liquid after reaching a terminal altitude according to the second embodiment of the present disclosure;

FIG. 12 is a photo obtained by dividing an image of a fire scene taken from the front using a deep learning filter according to a third embodiment of the present disclosure;

FIG. 13 is a table for comparing the case of extinguishing a wildfire using a firefighting helicopter in the related art and the case of extinguishing a wildfire using an AI air-to-ground guidance control device for extinguishing a wildfire according to the present disclosure;

FIG. 14 is a model diagram illustrating the case of dropping one wildfire extinguishing device when extinguishing a wildfire using a firefighting helicopter according the present disclosure;

FIG. 15 is a model diagram illustrating the case of dropping a plurality of wildfire extinguishing devices using a parachute when extinguishing a wildfire using a large transport aircraft according to the present disclosure; and

FIG. 16 is a model diagram illustrating the case of dropping a plurality of eco-friendly wildfire extinguishing devices when extinguishing a wildfire using an unmanned aerial vehicle according to the present disclosure.

### DETAILED DESCRIPTION OF THE EMBODIMENT

The advantages and features of the present disclosure and methods for achieving them will become clear by referring to the embodiments described in detail below along with the accompanying drawings. However, the present disclosure is not limited to the embodiments disclosed below and may be implemented in various different forms. The embodiments of the present disclosure are merely provided to ensure that the present disclosure is complete and to fully inform a person skilled in the art, to which the present disclosure pertains, of the scope of the present disclosure, and the present disclosure is only defined by the scope of the claims.

The terminology used in the present disclosure is for describing embodiments and is not intended to limit the present disclosure. As used in the present disclosure, singular forms also include plural forms, unless specifically stated otherwise in the context. As used in the present disclosure, the terms “comprises” and/or “comprising” do not exclude the presence or addition of one or more other components in addition to mentioned components. Like reference numerals refer to like components throughout the present disclosure, and the term “and/or” includes each of components mentioned and every combination of one or more of the components. Although the terms “first,” “second,” etc. are used to describe various components, these components are of course not limited by these terms. These terms are merely used to distinguish one component from another. Therefore, it goes without saying that a first component mentioned below may also be a second component within the technical idea of the present disclosure.

Unless otherwise defined, all terms (including technical and scientific terms) used in the present disclosure may be used with meanings commonly understood by those skilled in the art to which the present disclosure pertains. Additionally, terms defined in commonly used dictionaries are not to be interpreted ideally or excessively unless clearly specifically defined.

Spatially relative terms such as “below,” “beneath,” “lower,” “above,” “upper,” etc. may be used to easily describe the correlation between a component and other components as illustrated in the drawings. Spatially relative terms should be understood as terms that include different directions of components during use or operation in addition to the directions illustrated in the drawings. For example, if a component shown in a drawing is flipped over, a component described as being “below” or “beneath” another component will be placed “above” the other component. Therefore, the illustrative term “below” may include both downward and upward directions. Components may also be oriented in other directions, so spatially relative terms may be interpreted according to the oriented directions.

Hereinafter, embodiments of the present disclosure will be described in detail with reference to the attached drawings.

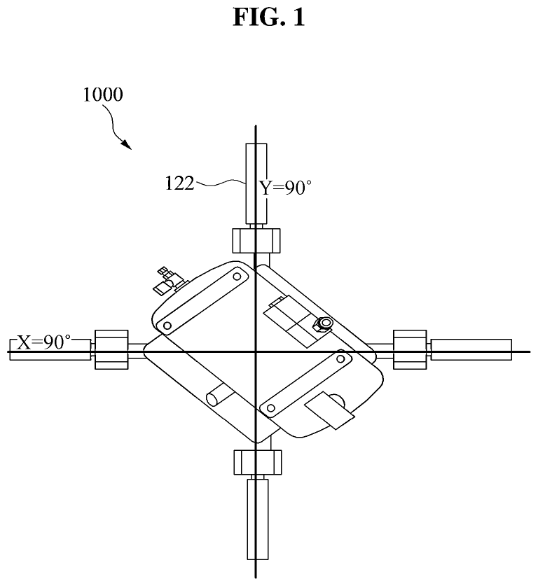

FIG. 1 is a plan photo of an air-to-ground guided wildfire extinguishing device according to one embodiment of the present disclosure, which includes a wildfire extinguishing device main body 100 and a plurality of fins 122.

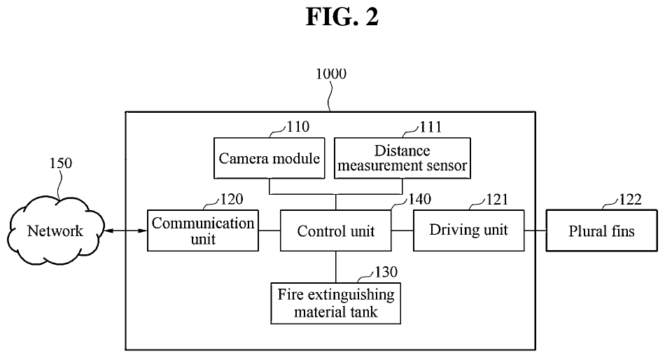

FIG. 2 is a block diagram of the wildfire extinguishing device illustrated in FIG. 1, where the wildfire extinguishing device main body 100 may include a camera module 110, a distance measurement sensor 111, a communication unit 120, a driving unit 121, and a fire extinguishing material tank 130, and a control unit 140.

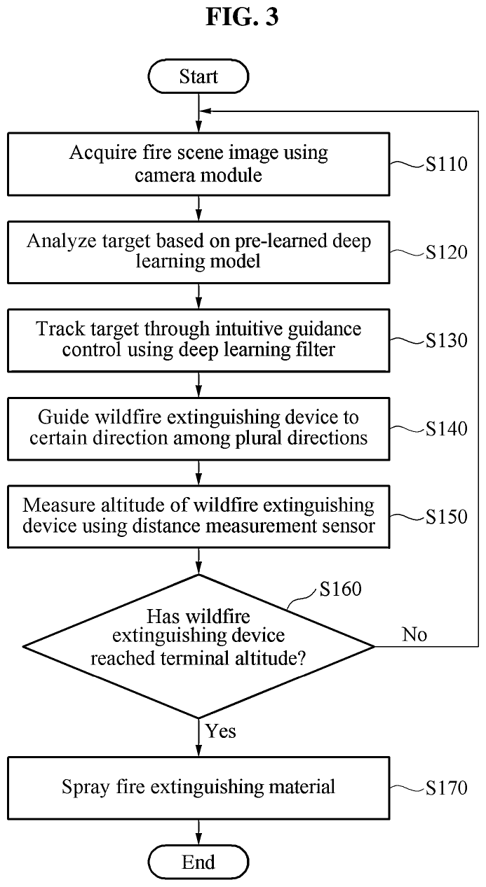

FIG. 3 is a flowchart illustrating a method for controlling an air-to-ground guided wildfire extinguishing device according to another embodiment of the present disclosure.

Hereinafter, the configuration and function of each component of an air-to-ground guided wildfire extinguishing device according to one embodiment of the present disclosure will be schematically described, with reference to FIGS. 1 to 4.

The camera module 110 may include an image sensor. The camera module 110 may receive an external optical signal in a set capturing (photographing mode), convert the external optical signal into an electrical signal, convert the electrical signal into digital data, and output the image data.

According to various embodiments, the wildfire extinguishing device main body 1000 may be configured in the form of a fire-retardant and/or flame-retardant flying structure and may be reused.

The plurality of fins 122 are provided on side surfaces of the wildfire extinguishing device main body 1000, and their angles may be individually adjusted in response to control of the driving unit 121. According to various embodiments, the plurality of fins 122 may be configured in the form of a fire-retardant and/or flame-retardant flying structure and may be reused.

The fire extinguishing material tank 130 may store an extinguishing material (e.g., fire extinguishing fluid, fire extinguishing powder) and the fire extinguishing material may be sprayed on a fire scene in response to the control of the control unit 140.

A parachute may suppress damage to a product due to a fall of the air-to-ground wildfire extinguishing device and increase drag when the wildfire extinguishing device falls for reuse of the wildfire extinguishing device.

The communication unit 120 may perform multiplex communication with at least one wildfire extinguishing device through a network 150 in an RF communication manner to share locations and targets.

The distance measurement sensor 111 may be configured to measure a distance from the ground to the air-to-ground guided wildfire extinguishing device. For example, the control unit 140 may determine whether the air-to-ground guided wildfire extinguishing device is located at a terminal altitude based on altitude detection data acquired using the distance measurement sensor 121.

The control unit 140 may be configured as a single-board or multi-board processor, and may receive image data from the camera module 110 to identify and recognize a wildfire shape, a smoke shape, object (e.g., person), and the like, and detect, identify, and/or track a pre-learned target.

The control unit 140 may control the driving unit 121 to adjust the plurality of fins 122 and control the posture and direction of movement of the wildfire extinguishing device.

The control unit 140 may receive altitude detection data detected through the distance measurement sensor 121 to determine whether a terminal altitude has been reached, and control the fire extinguishing material stored in the fire extinguishing material tank 130 to be sprayed at an appropriate location of a fire scene.

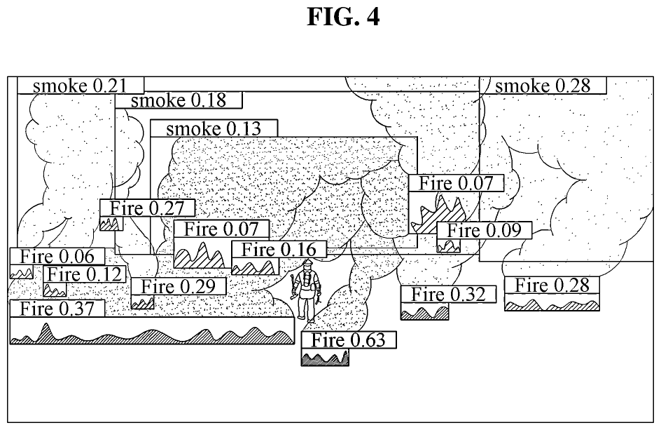

FIG. 4 is a deep learning image of a nighttime wildfire that has actually occurred in Colorado, USA in August 2020.

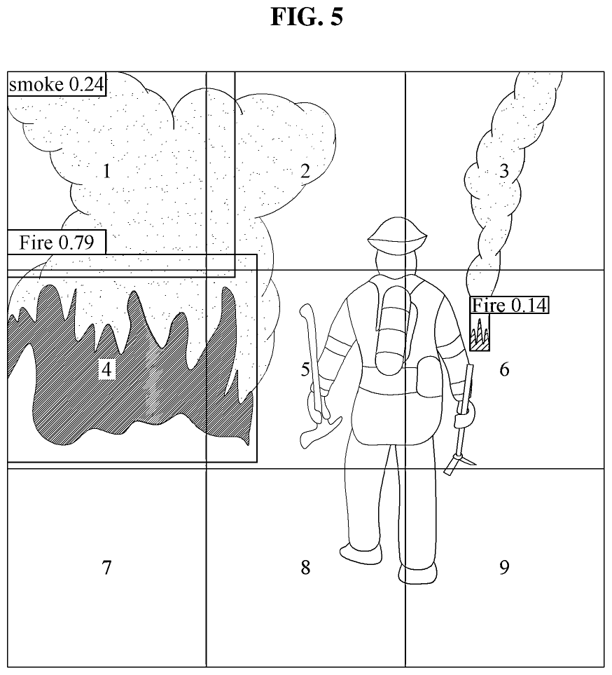

FIG. 5 is an image obtained by dividing an image of a fire scene taken from the front using a deep learning filter according to a first embodiment of the present disclosure.

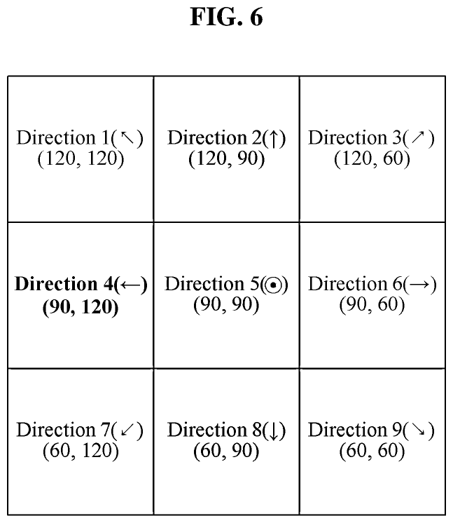

FIG. 6 is a diagram illustrating a direction in which the wildfire extinguishing device moves in the image of the fire scene divided according to the first embodiment of the present disclosure illustrated in FIG. 5.

Hereinafter, the operation of the air-to-ground guided wildfire extinguishing device according to the first embodiment of the present disclosure will be described in detail, with reference to FIGS. 4 to 6.

The present disclosure implements a guidance function by detecting and tracking wildfires through image deep learning and then adjusting angles of the fins 122 attached to the wildfire extinguishing device.

According to various embodiments, the air-to-ground guided wildfire extinguishing device may acquire an image of a fire scene, which includes at least one of a wildfire shape, a smoke shape, and a person, using a charge coupled device (CCD) built in the camera module 110 (S110).

According to various embodiments, the air-to-ground guided wildfire extinguishing device analyzes images of wildfire shapes, smoke shapes, and objects that are objects of a convolutional neural network (CNN) model that has been pre-learned through deep learning (S120).

According to various embodiments, the air-to-ground guided wildfire extinguishing device tracks images of wildfires and smoke through an AI deep learning technology, and performs intuitive position control of the wildfire extinguishing device after deep learning using a Nona filter that is a compound word of the Greek number ‘Nona’ representing ‘9’ and a ‘filter’ to extract a core.

For example, an object value, confidence value, and image pixel square of the deep learning result in the 9-segmented image may be calculated to actuate a posture control (position shift) function toward a zone having the highest weight, thereby utilizing control of the fins 122 through a servomotor, control through spraying of high-pressure compressed fire extinguishing fluid, etc.

As illustrated in FIG. 4, as results of pre-trained deep learning of Yolov8n model for 2,000 sheets of wildfire and smoke images, the instances were 3,600 fires and 1,000 smoke.

And, as the results of validation of the pre-trained model based on 748 images, 1,530 instances, precision of 0.736, recall of 0.583, and mAP50 of 0.638 were derived.

Accuracy and computational amount were validated on a single board computer (SBC) to be used for guidance control of the wildfire extinguishing device.

As a result, the accuracy with an error within 1% were obtained for both a simulator and the single board computer (SBC), and the computational amount resulted in that inference of the single board computer was 19.4 times slower than that of the simulator and the inference was decreased to 7.9 times that of the simulator when switching to Open Vino 2024.

According to various embodiments, the air-to-ground guided wildfire extinguishing device may track a target using a pre-trained deep learning filter (e.g., Nona filter) (S130).

For example, targets are generated simultaneously due to the nature of wildfires.

As illustrated in FIG. 4, a total of 25 instances, including 21 flames, 4 smoke, etc. were detected under the condition that the confidence index was 0.05 or higher.

Here, a deep learning filter (Nona filter) is used for intuitive target tracking during air-to-ground guidance control. The deep learning filter computes a total value, as expressed in Equation 1 below, by multiplying an object value in the detected image, a confidence value of an AI model, and an image pixel square, and guides a target in an area where the highest value is computed.

The wildfire extinguishing device determines its direction to drop on Cartesian coordinates (X and Y axes).

$$Total Value = Object value \times Confidence value \times Image pixel square \qquad [ Equation 1 ]$$

Next, according to various embodiments, the guidance control for the air-to-ground guided wildfire extinguishing device toward a plurality of directions (e.g., nine directions) are made using the plurality of fins (S140).

As illustrated in the first embodiment of FIG. 5, the image captured through the camera module 110 is segmented (divided) into 9 equal parts in directions 1 to 9, and a total value is computed using Equation 1 above for each direction.

For example, the object value is set to 1.0 point for flame and 0.8 point for smoke, the confidence index value is set to 0.0 to 1.0 points, and the image pixel square is set flexibly depending on a camera pixel.

Accordingly, for the direction 1 where lots of smoke are visible, a total value of smoke (0.8)×confidence index value (0.24)×image pixel square (160×160)=4,915.2 is computed.

Also, for the direction 4 where lots of flames are visible, a total value of smoke (1.0)×confidence index value (0.79)×image pixel square (150×150)=17,775 is computed.

Additionally, for direction 6 where lots of flames are visible but the confidence index value and pixel square are small, a total value of smoke (1.0)×confidence index value (0.14)×image pixel square (10×10)=14 is computed.

For the remaining directions 2, 3, 5, 7, 8, and 9 where much flames or smoke are invisible, the confidence index value is close to ‘0’, so total values are computed as ‘0’.

Using the total values computed in this way, guidance control is performed to convert an electrical signal into a physical motion by applying the total values to a guidance control matrix.

That is, since the total value is the highest for the direction 4, as illustrated in FIG. 5, the wildfire extinguishing device moves from the direction 5, which is located at a center, to the direction 4, which is a left movement guidance control direction.

Next, according to various embodiments, the air-to-ground guided wildfire extinguishing device may measure an altitude thereof using the distance measurement sensor 111 (e.g., laser range finder (LRF) (S150), barometer, Thermometer, GPS Module, etc), and determine whether it has reached a terminal altitude (S160).

When it is determined that the wildfire extinguishing device has reached the terminal altitude, the wildfire extinguishing device sprays the fire extinguishing material (e.g., fire extinguishing water, fire extinguishing liquid, fire extinguishing agent, fire extinguishing bomb, etc.) (S170), and when it is determined that it has not reached the terminal altitude, returns to the step S110, and repeats the subsequent operations.

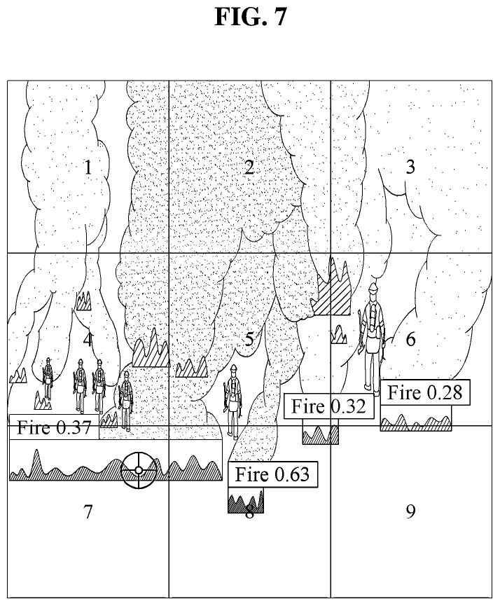

FIG. 7 is an image obtained by dividing an image of a fire scene taken from the front using a deep learning filter according to a second embodiment of the present disclosure.

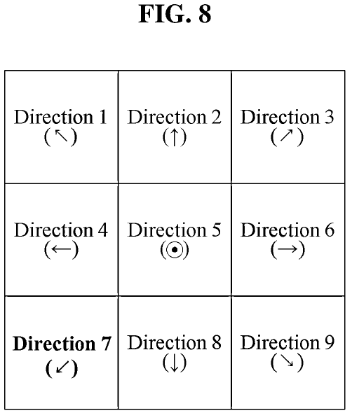

FIG. 8 is a diagram illustrating a direction in which a wildfire extinguishing device moves in the image of the fire scene divided according to the second embodiment of the present disclosure illustrated in FIG. 7.

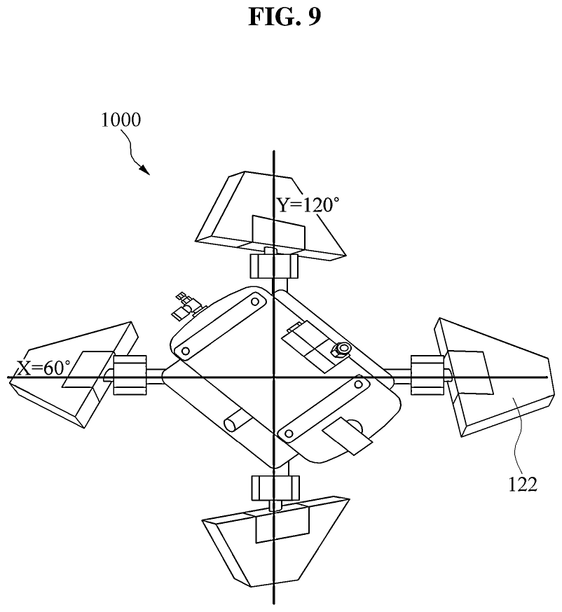

FIG. 9 is a plan image of the wildfire extinguishing device in which fin angles of fins attached to a servomotor in the wildfire extinguishing device illustrated in FIG. 1 has been adjusted by certain angles in X-axis and Y-axis directions.

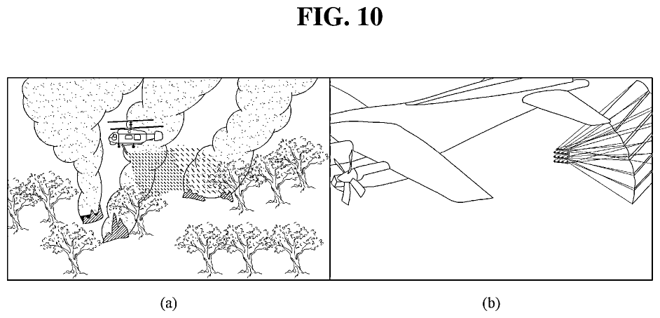

FIG. 10 shows a photo (a) of extinguishing a wildfire using an existing firefighting helicopter and a photo (b) of a fire extinguishing device being dropped from an artificial intelligence (AI) air-to-ground guidance control device for extinguishing wildfires according to the present disclosure.

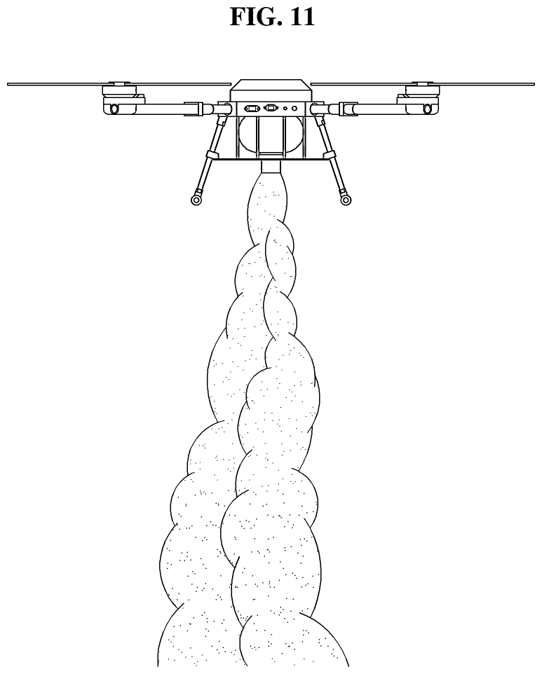

FIG. 11 is a photo of a wildfire extinguishing device spraying fire extinguishing liquid after reaching a terminal altitude according to the second embodiment of the present disclosure.

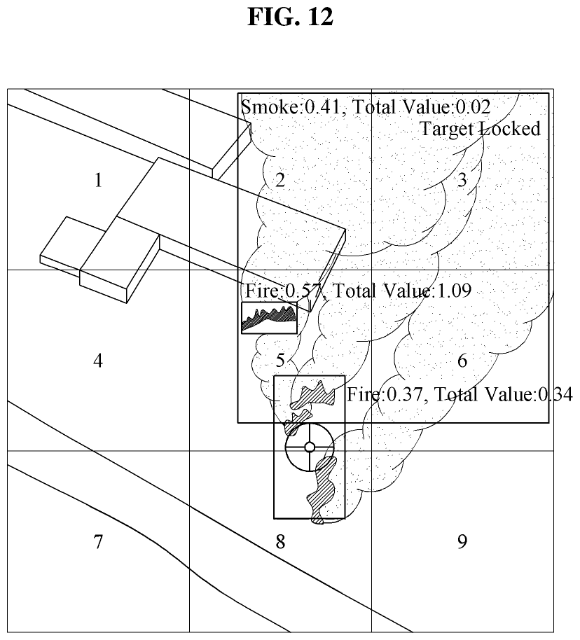

FIG. 12 is a photo obtained by dividing an image of a fire scene taken from the front using a deep learning filter according to a third embodiment of the present disclosure.

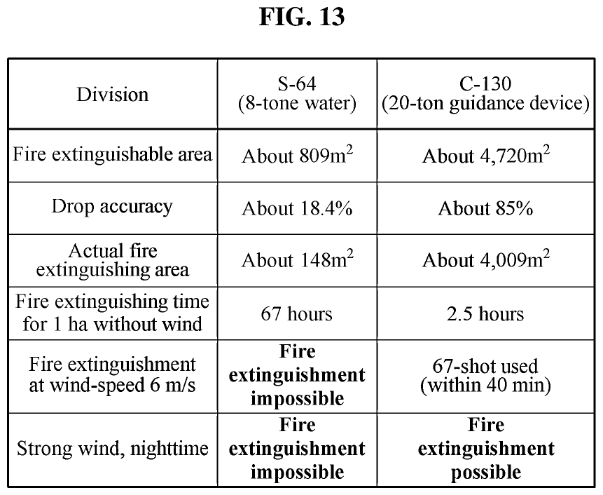

FIG. 13 is a table for comparing the case of extinguishing a wildfire using a firefighting helicopter in the related art and the case of extinguishing a wildfire using an AI air-to-ground guidance control device for extinguishing wildfires according to the present disclosure.

Hereinafter, the operation of the air-to-ground guided wildfire extinguishing device according to the second and third embodiments of the present disclosure will be described in detail, with reference to FIGS. 7 to 13.

As another embodiment, as illustrated in the second embodiment of FIG. 7, the image captured through the camera module 110 is segmented into 9 equal parts in the directions 1 to 9 when flame is set to 15 points, smoke to 0.1 point, and person to 0 point for the weight of the object value, and a total value for each direction is computed using Equation 1 above.

At this time, when it is assumed that the confidence index value in the direction 7 is 0.5 and the image pixel square is 7828, the total value is 58,710, which is the maximum value.

Therefore, in FIG. 8, a direction of movement from the central position (the direction 5) to the direction 7 is southwest, and as illustrated in FIG. 9, the fin angles of the fins 122 of the wildfire extinguishing device, which are attached to the servomotor, are adjusted to 60 degrees on the X-axis and 120 degrees on the Y-axis, such that the wildfire extinguishing device which has been located in the direction 5 moves to the direction 7.

At this time, the same number of servomotors as the number of the fins 122 of the wildfire extinguishing device is provided, and the servomotors are re-directed on the Cartesian coordinates illustrated in FIG. 6, and controls an initial guidance by changing the fin angles in units of 60°, 90°, and 120°.

When a terminal altitude (terminal height) is recognized at an altitude of about 100 m through a laser ranger finder (LRF), a target on which a wildfire extinguishing agent is to be sprayed is trimmed in units of 3°.

When the trimming is completed, the fire extinguishing material which has been sealed in the fire extinguishing material tank 123 is sprayed on a target by spraying CO₂ in an air tank on the target after a lapse of a certain time (e.g., 3 seconds).

Meanwhile, the AI air-to-ground guidance control device for extinguishing wildfires according to the present disclosure may extinguish a fire in the form of a wildfire extinguishing device in the range of about 3.3 m² per one shot.

Additionally, comparing with firefighting helicopters (e.g., S-64) in the related art, it is possible to precisely drop wildfire extinguishing devices even under adverse conditions such as strong winds, nighttime, drought, and smoke, which are the causes of wildfire spread.

The accuracy of dropping wildfire extinguishing devices may vary depending on a pilot's skill and aircraft performance, but as illustrated in FIG. 13, when comparing with a firefighting helicopter (S-64), a transport aircraft (C-130) obtains more effective results of about 5 times extinguishable area, about 4.6 times drop accuracy, about 27 times actual wildfire extinguishing area, and 26.8 times fire extinguishing time for 1 ha without wind.

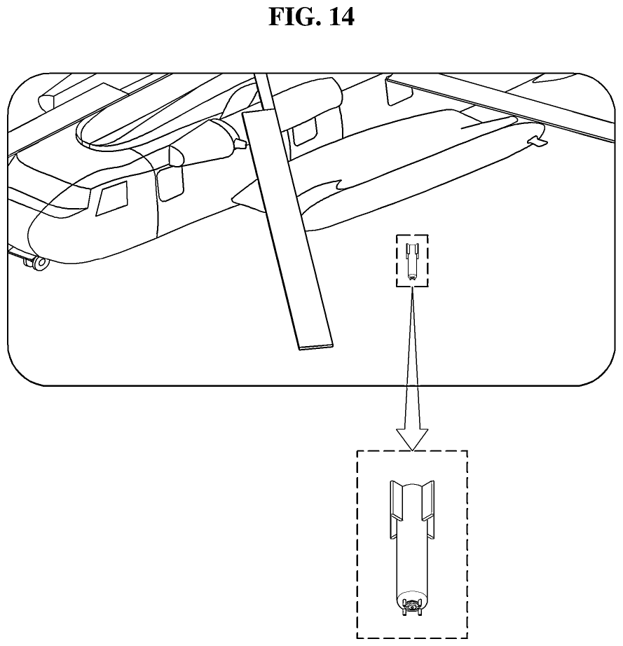

FIG. 14 is a model diagram illustrating the case of dropping one wildfire extinguishing device when extinguishing a wildfire using a firefighting helicopter according to the present disclosure.

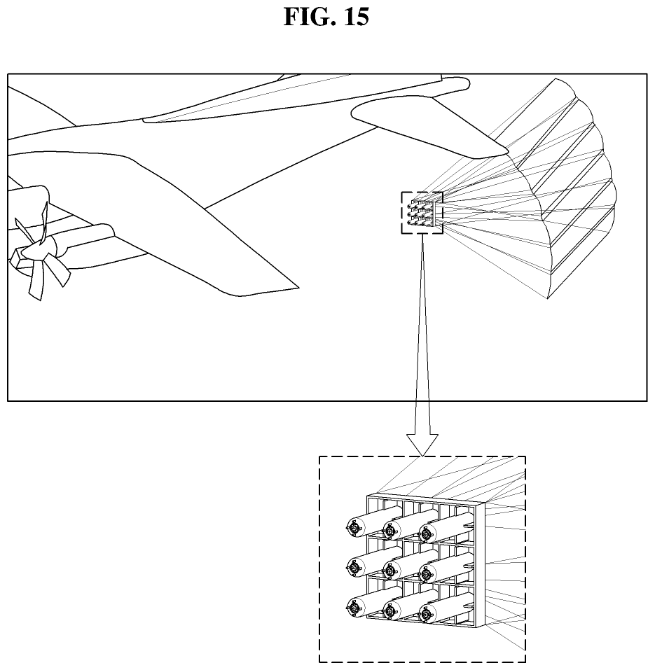

FIG. 15 is a model diagram illustrating the case of dropping a plurality of wildfire extinguishing devices using a parachute when extinguishing a wildfire using a large transport aircraft according to the present disclosure.

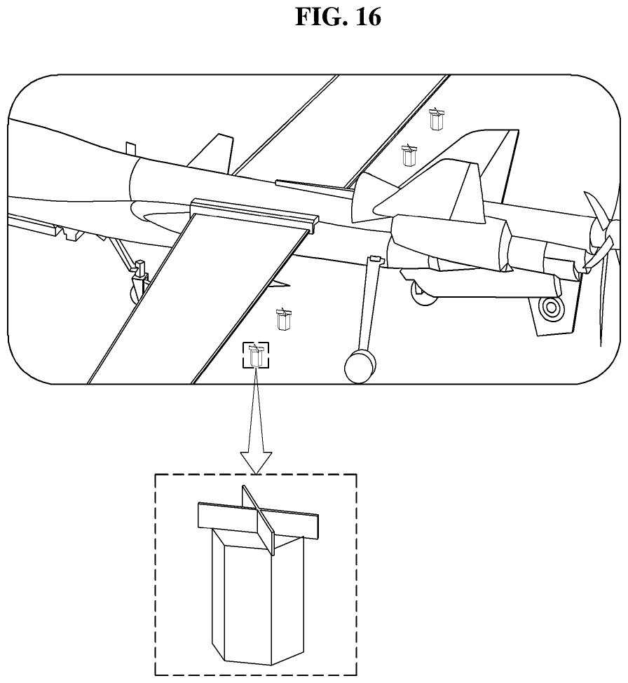

FIG. 16 is a model diagram illustrating the case of dropping a plurality of eco-friendly wildfire extinguishing devices when extinguishing a wildfire using an unmanned aerial vehicle according to the present disclosure.

Hereinafter, the operation of dropping various types of wildfire extinguishing devices in the air-to-ground guided wildfire extinguishing device according to the present disclosure will be described in detail, with reference to FIGS. 14 to 16.

As illustrated in FIG. 14, a simulation system of estimating a unity-based digital twin wildfire heat quantity is constructed when extinguishing a wildfire using the air-to-ground guided wildfire extinguishing device according to the present disclosure through a firefighting helicopter.

At this time, the wildfire extinguishing device to be dropped is artificially intelligent, is made of aluminum alloy, includes a detection unit, a chemical unit, a high-pressure tank, and a control unit, and is designed in a structure that minimizes a drop impact when dropped for reuse (e.g., to have a plurality of fins on an upper outer peripheral surface when dropped).

In addition, as illustrated in FIG. 15, at least one wildfire target is assigned in near real time when extinguishing the wildfire using the air-to-ground guided wildfire extinguishing device according to the present disclosure through a large transport aircraft (for example, airlifter, cargo aircraft and so on).

At this time, the wildfire extinguishing device to be dropped is of a multi-drop type, and includes a plurality of drones (e.g., nine drones in a 3×3 case), and one deceleration parachute to which upper ends of the drones are connected when dropped. It is designed in a structure that a plurality of AI wildfire extinguishing devices are dropped at the same time and then landed in a preset safety area.

In addition, as illustrated in FIG. 16, when extinguishing a wildfire using the air-to-ground guided wildfire extinguishing device according to the present disclosure through an unmanned aerial vehicle, fusion sensors (e.g., synthetic aperture radar (SAR)+electro-optics (EO)/infra-red (IR)) and low-orbit satellites are utilized.

At this time, the wildfire extinguishing device to be dropped is eco-friendly and is made using a vegetable insulating material and an adhesive. The eco-friendly wildfire extinguishing devices are designed to be mounted to a formation of a plurality of unmanned aerial vehicles and the unmanned aerial vehicles are returned after the eco-friendly wildfire extinguishing devices are dropped.

As such, the present disclosure provides an air-to-ground guided wildfire extinguishing device that is capable of extinguishing a wildfire within a shortest time by dropping a plurality of extinguishing devices in the air, using a manned or unmanned aircraft with a high maximum take-off weight, onto the wildfire with an error within a very small radius through precise guidance by utilizing a deep learning object detection technology and robot control technology.

Through this, the wildfire extinguishing device uses a camera module and is designed to be reusable, thereby lowering the production cost of a product, and reducing an economic burden even when a large quantity of fire extinguishing water is dropped.

By using a filter that performs intuitive position control of a wildfire extinguishing device after deep learning, a computational amount is reduced and intuitive posture control is allowed, compared to a Kalman filter that controls the position of a robot in the related art.

In addition, a large quantity of firefighting water may be dropped on a point where a fire started through a large manned and unmanned transport aircraft with a high maximum take-off weight.

In addition, fire extinguishing powder may be recharged, and a drop speed of the wildfire extinguishing device may be delayed by designing high lift through high-pressure fluid spray and high drag through a parachute to reduce potential energy when dropped from a high position in the air.

The method according to the present disclosure described above may be implemented as a program (or application) and stored in a medium in order to be executed in conjunction with a server, which is hardware.

The program may include codes encoded in a computer language, such as C, C++, JAVA, machine language, etc. that may be read by a control unit (CPU) of a computer through a device interface of the computer so that the computer reads the program and executes methods implemented as the program. These codes may include functional codes related to functions that define necessary functions for executing the above methods, and may include control codes related to execution procedures necessary for the control unit of the computer to execute the above functions according to predetermined procedures. In addition, these codes may further include a storage reference-related code indicating a location (the number of an address), at which additional information or media required for the control unit of the computer to execute the above functions should be referenced, in an internal or external storage medium of the computer. Additionally, if the control unit of the computer needs to communicate with any other remote computer or server to execute the above functions, the codes may further include communication-related codes associated with a communication method with any other computer or server located at a remote distance using a communication module of the computer, any information or media to be transmitted and received during communication, etc.

The storage medium refers to a medium that stores data semi-permanently and may be read by a device, rather than a medium that stores data for a short period of time, such as a register, cache, or storage unit. Specifically, examples of storage media include, but are not limited to, ROM, RAM, CD-ROM, magnetic tape, floppy disk, optical data storage device, and the like. That is, the program may be stored in various recording media on various servers that the computer may access or in various recording media on the user's computer. Additionally, the media may be distributed to computer systems connected through networks, and store computer-readable codes in a distributed manner.

The steps of the method or algorithm described in connection with the embodiments of the present disclosure may be implemented directly in hardware, implemented as a software module executed by hardware, or a combination thereof. The software module may also be present in random access memory (RAM), read only memory (ROM), erasable programmable ROM (EPROM), electrically erasable programmable ROM (EEPROM), flash memory, hard disk, removable disk, CD-ROM, or an arbitrary type of computer-readable recording medium well known in the art to which the present disclosure pertains.

As such, the embodiments of the present disclosure have been described with reference to the attached drawings, but those skilled in the art will understand that the present disclosure may be implemented in other specific forms without changing its technical idea or essential features. Therefore, the embodiments described above are illustrative in all aspects and should not be understood as being restrictive.

What is claimed is:

1. An air-to-ground guided wildfire extinguishing device comprising:
a camera module that captures an image including a fire scene;
a distance measurement sensor that measures a distance from a ground;
a control unit that receives the image from the camera module, recognizes at least one of a wildfire shape, smoke shape, and object included in the image, detects, identifies, or tracks a pre-learned target, controls a moving direction of the wildfire extinguishing device to correspond to the target, and determines a terminal altitude based on altitude detection data obtained from the distance measurement sensor; and
a fire extinguishing material tank that is configured to spray a fire extinguishing material on the fire scene based on a signal received from the control unit.

2. The air-to-ground guided wildfire extinguishing device of claim 1, further comprising:
a communication unit that performs multiplex communication with at least one other wildfire extinguishing device through radio frequency (RF) communication to share relative positions and targets.

3. The air-to-ground guided wildfire extinguishing device of claim 1, wherein the control unit detects a target through intuitive guidance control using a deep learning filter.

4. The air-to-ground guided wildfire extinguishing device of claim 3, wherein the deep learning filter is a Nona filter.

5. The air-to-ground guided wildfire extinguishing device of claim 4, wherein the deep learning filter calculates a total value by multiplying an object value in a detected image, a confidence index value of an artificial intelligence (AI) model, and an image pixel square, and guides toward the target of an area where a largest total value is calculated.

6. The air-to-ground guided wildfire extinguishing device of claim 5, wherein a guidance control of the wildfire extinguishing device is performed to convert an electrical signal into a physical action by applying the calculated total value to a guidance control matrix.

7. A method for controlling an air-to-ground guided wildfire extinguishing device, the method comprising:
(a) acquiring an image of a fire scene using a camera module, the image including at least one of a wildfire shape, smoke shape, and object;
(b) analyzing and tracking a target through a pre-learned model based on the acquired image using a control unit;
(c) guiding the wildfire extinguishing device in a certain direction among a plurality of directions using the control unit;
(d) measuring an altitude of the wildfire extinguishing device using a distance measurement sensor; and
(e) spraying a fire extinguishing material using a fire extinguishing material tank when it is determined that the measured altitude has reached a terminal altitude.

8. The method of claim 7, wherein the step (e) comprises returning to the step (a) when it is determined that the measured altitude has not reached the terminal altitude.

9. The method of claim 7, wherein the fire extinguishing material is one or more of fire extinguishing water, fire extinguishing liquid, fire extinguishing powder, fire extinguishing agent, fire extinguishing bomb.

10. The method of claim 9, wherein the wildfire extinguishing device constructs a simulation system of estimating a unity-based digital twin wildfire heat quantity when extinguishing a wildfire using the wildfire extinguishing device through a firefighting helicopter.

11. The method of claim 10, wherein the wildfire extinguishing device has a structure with a plurality of fins on an upper outer peripheral surface to minimize a drop impact for reuse.

12. The method of claim 9, wherein the wildfire extinguishing device is assigned at least one wildfire target in near real time when extinguishing the wildfire using the wildfire extinguishing device through a large transport aircraft.

13. The method of claim 12, wherein the wildfire extinguishing device is configured to include a plurality of drones and one deceleration parachute to which upper ends of the drones are connected when dropped.

14. The method of claim 9, wherein the wildfire extinguishing device utilizes fusion sensors and low-orbit satellites when extinguishing a wildfire using the wildfire extinguishing device through an unmanned aerial vehicle.

15. The method of claim 14, wherein the wildfire extinguishing device is manufactured using a vegetable insulating material and an adhesive.

16. A non-transitory computer-readable recording medium of an air-to-ground guided wildfire extinguishing method, in which a program for performing the air-to-ground guided wildfire extinguishing method according to claim 7 on a computer is recorded.
